(19) United States
(12) Patent Application Publication
(10) Pub. No.: US 2026/0359296 A1
(43) Pub. Date: Nov. 12, 2026

(54) HEURISTIC ASSISTANT FOR GUIDED RECOMMENDATION FOR DATA PRE-PROCESSING

(71) Applicant: American Express Travel Related Services Company, Inc., New York, NY (US)

(72) Inventors: Shivam Arya, Hisar (IN); Madhav Pola, Bengaluru (IN); Krishnaprasad Narayanan, Bengaluru (IN); Radhakrishnan Gopalakrishnan, Gurugram (IN); Madhurima Khandelwal Gupta, Gurugram (IN); Mamta Aggarwal Rajnayak, New Delhi (IN); Aanshi Rustagi, Gurugram (IN); Shourya Munim, Gurugram (IN); Arindam Chatterjee, Scottsdale, AZ (US); Gautam Garg, Bengaluru (IN); Vishnuprakash Puthiya Kovilakath, Bengaluru (IN)

(21) Appl. No.: 19/205,031

(22) Filed: May 12, 2025

(51) Int. Cl. G06F 16/2453; G06F 16/215; G06F 16/22

(52) U.S. Cl. CPC G06F 16/2453; G06F 16/215; G06F 16/2282

(57) ABSTRACT

Disclosed are various embodiments for a heuristic assistant for guided recommendations for data preprocessing jobs. A computing device can extract a plurality of data components from a data pre-processing query in response to receiving a description of a task, wherein the data components include at least one or more tables, one or more operations, or one or more timeframes and can identify at least one or more custom tables and convert the one or more custom tables into one or more platform tables and sort the one or more table based at least in part on a partition size category or a partition quantity category. Finally, the computing device can determine a rank ordered resource recommendation based at least in part on the partition size category, the partition quantity category, the operations, or the timeframes and can allocate resources based at least in part on the rank ordered resource recommendation.

### BACKGROUND

Databases containing raw data are generally messy and unorganized. Often, raw data can be duplicative, erroneous, or disorderly. Machine learning platforms can consume vast amounts of data for analysis, but duplicative, erroneous, or disorganized raw data can affect the quality of analysis of the raw data.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a graphical illustration of a global minima formation. The graph compares spark resource configuration (X-axis) to the time for initiation and execution (Y-axis) according to various embodiments of the present disclosure.

FIG. 3 is a flowchart illustrating one example of functionality implemented as portions of an application executed in a computing environment in the network environment of FIG. 1 according to various embodiments of the present disclosure.

FIG. 4 is a flowchart adding more detail to the flowchart in FIG. 3 by illustrating one example of functionality implemented as portions of an application executed in a computing environment in the network environment of FIG. 1 according to various embodiments of the present disclosure.

FIG. 5 is a flowchart adding more detail to the flowchart in FIG. 3 by illustrating one example of functionality implemented as portions of an application executed in a computing environment in the network environment of FIG. 1 according to various embodiments of the present disclosure.

FIG. 6 is a flowchart adding more detail to the flowchart in FIG. 3 by illustrating one example of functionality implemented as portions of an application executed in a computing environment in the network environment of FIG. 1 according to various embodiments of the present disclosure.

### DETAILED DESCRIPTION

Disclosed are various approaches for a heuristic assistant for guided recommendations for data preprocessing jobs. The various embodiments of the present disclosure can provide an end-to-end system for running data pre-processing jobs. In various examples of the present disclosure, the data preprocessing jobs can include allocating resources for tasks (e.g., training a machine learning model, data mining, etc.). Tasks can then be performed on servers, clusters of servers, etc., after the change in the allocation of resources, thereby improving the performance of the task. Various embodiments of the present disclosure can link different entities of data analytics codes with the underlying infrastructure. For example, various embodiments of the present disclosure can provide optimal compute configurations to data creators and modelling teams when running the data preprocessing jobs on the platform. In addition, various embodiments of the present disclosure can be built based at least in part on data pre-processing logics deployed on production, thus ensuring the generated recommendations unlock optimal compute allocations while enabling high data preprocessing job success rates. Further in some examples, various embodiments of the present disclosure can leverage a machine learning platform in a shared infrastructure environment. Thus, various embodiments of the present disclosure can provide an enhanced user experience on a shared computing environment.

For example, many tools in a service-oriented architecture do not have the ability to link the data pre-processing code with its complexity to compute resources. Other service-oriented architecture services are not intuitive to use or have a high learning curve for users. Further, known service-oriented architecture services, specifically external or third-party tools, are designed to leverage cloud platforms where there is a significant infrastructure requirement or usage planned.

The various embodiments of the present disclosure offer several benefits for data pre-processing. For example, various embodiments of the present disclosure can map user data pre-processing code and logic to underlying resources, thereby providing optimized compute configurations based at least in part on the underlying resources for the data pre-processing job. Further, various embodiments of the present disclosure can provide a real time resource recommendation basis to support a data pre-processing query that can be powered by various machine learning platforms. Moreover, various embodiments of the present disclosure can employ a “low-code” or “no code” interface by generating recommended settings to optimize the compute allocations, which helps efficient utilization of limited resources. Additionally, various embodiments of the present disclosure can provide rank ordered resource recommendations for optimizing data pre-processing jobs. According to various embodiments of the present disclosure, the task can be executed using an optimized resource allocation based at least in part on the rank ordered resource recommendations, thereby improving the performance of the task.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

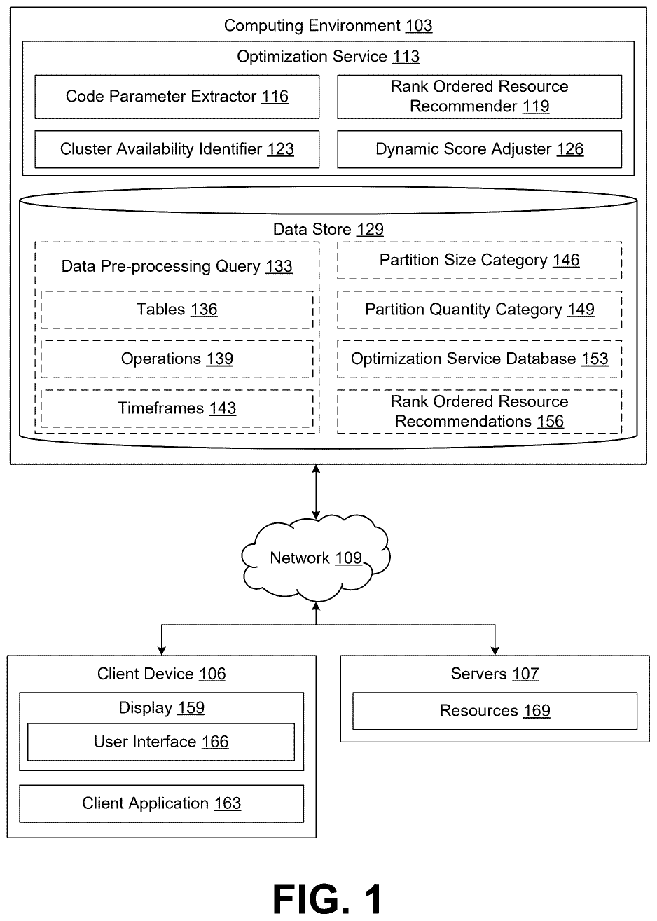

With reference to FIG. 1, shown is a network environment 100 according to various embodiments. The network environment 100 can include a computing environment 103, a client device 106, and servers 107, which can be in data communication with each other via a network 109.

The network 109 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 109 can also include a combination of two or more networks 109. Examples of networks 109 can include the Internet, intranets, extranets, virtual private networks (VPNs), and similar networks.

The computing environment 103 can include one or more computing devices that include a processor, a memory, or a network interface. For example, the computing devices can be configured to perform computations on behalf of other computing devices or applications. As another example, such computing devices can host or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 include an optimization service 113 and other applications, services, processes, systems, engines, or functionality not discussed in detail herein.

The optimization service 113 can be executed to perform data preprocessing jobs to prepare raw data for analysis. The optimization service 113 can generate recommendations for optimal compute allocations, facilitating a smooth user experience. To generate the recommendations, the optimization service 113 can map the data preprocessing code to the underlying resources. The optimization service 113 can also create an optimization service database 153. In some examples, the optimization service 113 can perform real time resource calibration based at least in part on user feedback on the original rank ordered resource recommendations 156. The optimization service 113 can execute various components to conduct the data pre-processing including a code parameter extractor 116, a rank ordered resource recommender 119, a cluster availability identifier 123, or a dynamic score adjuster 126.

The code parameter extractor 116 can be executed to extract data components (e.g., tables 136, operations 139, timeframes 143, etc.) from a data pre-processing query 133. By using the code parameter extractor 116 to extract data components from a data pre-processing query 133, the optimization service 113 can make an estimation of the quantum of the data used in the data pre-processing query 133. The code parameter extractor 116 can identify the tables 136 in the data pre-processing query 133, using a structured query language (SQL) metadata package in various examples. In some examples, the code parameter extractor 116 can perform a search (e.g., regular expression search) for the operations 139 in an area around the tables 136. Further, in some examples, the code parameter extractor 116 can identify configuration variables defining the timeframes 143.

The code parameter extractor 116 can also have support for custom databases. With custom database support, the code parameter extractor 116 can identify custom, or non-database, tables. Once the code parameter extractor 116 identifies the non-database tables, the code parameter extractor 116 can convert the non-database tables to platform tables based at least in part on the properties of the data. To convert the non-database tables, the code parameter extractor 116 can calculate the size of the custom database tables using the path provided by a user in some examples. In these examples, since the whole table is read by the user, the number of partitions is set to one (1). The calculated size of the non-database tables can be mapped using the partition size of platform tables by multiplying the size of the custom table by a compression factor. For example, tables stored locally can be in multiple formats (e.g., CSV, Parquet, ORC, Hive, etc.) and for each format, there can be a compression factor which can be multiplied to get the real size thus mapping the non-database table to a platform table.

The rank ordered resource recommender 119 can be executed to generate a resource recommendation for a data preprocessing logic. The rank ordered resource recommender can optimize the total time taken to run a data pre-processing query 133, including the time of gathering the resources and the time of running the data pre-processing query 133 using those resources. In some examples, the rank ordered resource recommender 119 can determine a partition size, where the partition size is the size of data which is stored in one partition of a table 136. In various examples, the rank ordered resource recommender 119 can use the timeframe of data (T) and the refresh frequency (f) of the table to calculate the number of partitions according to Equation 1, where the refresh frequency is the timeframe in which new data is added in the table 136. Based at least in part on these calculations, the rank ordered resource recommender 119 can sort the tables 136 based at least in part on the partition size category 146 or the partition quantity category 149.

$$\frac{T}{f} = \# of Partitions \qquad ( 1 )$$

The rank ordered resource recommender 119 can determine a rank ordered resource recommendation 156 based at least in part on the partition size category 146, the partition quantity category 149, the operations 139, or the timeframes 143. For example, the rank ordered resource recommender 119 can map the partition size category 146, the partition quantity category 149, the operations 139, or the timeframes 143 to the optimization service database 153. In some examples, the rank ordered resource recommender 119 can generate a combination of setting for individual sub queries. Further in some examples, the rank ordered resource recommender 119 can rank the combination of settings based at least in part on the time of initiation and execution. Thus, the rank ordered resource recommender 119 can determine the highest tanked combination of settings as the rank ordered resource recommendation 156. In various examples, the timeframes of initiation and execution of the highest ranked combination of settings, or the rank ordered resource recommendation 156, is a fraction (e.g. 10%) of a global minima of the timeframes of initiation and execution compared to a number of resources.

The cluster availability identifier 123 can be executed to determine additional resources that can be allocated to each of the queried jobs based at least in part on notice from a user requesting an additional recommendation of settings. For example, the cluster availability identifier 123 can identify current cluster utilization and space availability. The cluster availability can, at a particular moment, play a significant role in deciding additional resources that can be allocated to each of the queued jobs. The average resource available at a particular timestamp per job (CUₜ) can be calculated using Equation 2, where n represents the average job count at a 30-minute time stamp over the last 2 years and r represents real-time cluster resource availability at that time stamp. Further, the cluster availability identifier 123 can map resource availability to average number of jobs at the timestamp. In various examples, resources allocated to a data pre-processing workload can be denoted by four factors including: executor memory (em), executor cores (ec), minimum executors (mie), and maximum executors (mae). In some examples, experiments can be run with multiple permutations of resource to identify the percentage of utilization of the cluster. For example, a regression model can be built mapping resources to percentage of utilization (U) according to equation 3, where R is the regression equation and U is the utilization of the cluster for those resources.

$${CU}_{t} = \frac{r}{n} \qquad ( 2 )$$

$$R : F ( ec , em , mie , mae ) = U \qquad ( 3 )$$

The dynamic score adjuster 126 can be executed to improve the rank ordered resource recommendations 156 based at least in part on user input. The dynamic score adjuster 126 can identify the resource availability per job at a timestamp and use that determination to increase the number of maximum executors corresponding to that resources age. In some examples, the cluster availability identifier 123 can adjust the maximum executor to modify the cluster utilization percentage. In other words, the maximum executor (mae) number can be tuned while keeping the other three (3) factors constant. For example, the dynamic score adjuster 126 can use the dynamic score adjuster equation, depicted in equation 4, to determine a revised rank ordered resource recommendation. In some examples, the final recommended settings can be calculated according to equation 5 where a represents the initial recommendation and f(t, n) represents the cluster snapshot where n represents the number of trials by the user and t represents the timestamp of the trial. The dynamic score adjuster 126 can combine the rank ordered resource recommendations 156 with the cluster utilization percentage to revise the rank ordered recommendations. The dynamic score adjuster 126 can be iterative to continue to adjust the rank ordered recommendation until the recommendations are accepted by the user. Post optimization, data can be stored in the optimization service database 153. The below equations prevent the overallocation of available shared resources thus avoiding a server failure.

$$( ( {\sum }_{i = 1}^{n} {0.5}^{n} ) * {CU}_{t} ) {⇒}_{{U}_{db}} f ( t , n ) \qquad ( 4 )$$

$$s = a + f ( t , n ) \qquad ( 5 )$$

Also, various data is stored in a data store 129 that is accessible to the computing environment 103. The data store 129 can be representative of a plurality of data stores 129, which can include relational databases or non-relational databases such as object-oriented databases, hierarchical databases, hash tables or similar key-value data stores, as well as other data storage applications or data structures. Moreover, combinations of these databases, data storage applications, or data structures may be used together to provide a single, logical, data store. The data stored in the data store 129 is associated with the operation of the various applications or functional entities described below. This data can include a data pre-processing query 133 (e.g., tables 136, operations 139, timeframes 143, etc.), partition size category 146, partition quantity category 149, optimization service database 153, rank ordered resource recommendations 156, and potentially other data.

The data pre-processing query 133 can represent a combination of tables 136, operations 139 applied on those tables, and timeframes 143 in which those tables are used. Often, data pre-processing queries 133 can use platform tables which are stored in a database and non-database tables which are created locally within the code.

The partition size category 146 can represent various size categories to sort tables based at least in part on the partition size. The partition size can be the size of the data which is stored in one partition of a table. In some examples, the partition size category 146 can be one of big, medium, and small. For examples, the big partition size category 146 can represent tables 136 with more than one-hundred (100) gigabytes of data per partition; the medium partition size category 146 can represent tables 136 with between one-hundred (100) and fifty (50) gigabytes of data per partition; and the small partition size category 146 can represent tables 136 with less than fifty (50) gigabytes of data per partition.

The partition quantity category 149 can represent various categories to sort tables based at least in part on the number of partitions. The number of partitions is calculated using the Timeframe of data (T) and the refresh frequency (f) of the table 136 according to Equation 1. In some examples, the partition quantity category 149 can be either small or large. For example, models with a small amount of data can represent tables with twelve (12) or less partitions and models with a large amount of data can represent tables with more than twelve (12) partitions.

The optimization service database 153 can represent the knowledge base for the optimization service 113. To create the optimization service database 153 in various examples, a basic split can be created identifying major tables 136 based at least in part on partitions. Further, in some examples, experiments can be run on multiple tables with different configuration settings. In some examples, the optimization service 113 can follow a bottom-up approach to optimize different operations to create the optimization service database 153. In various examples, experimentation and successful execution results are stored in the optimization service database 153. For example, the optimization service database 153 can capture the complexity of joins, ODLs, variables, and initialization parameters for each execution.

The rank ordered resource recommendations 156 can represent setting recommendations that can help optimize data pre-processing jobs. The rank ordered resource recommendations 156 can initialize and fast track the execution. For example, the rank ordered resource recommendations 156 can improve the execution times. In some examples, the rank ordered resource recommendations 156 can reduce big data cluster downtimes.

The client device 106 is representative of a plurality of client devices that can be coupled to the network 109. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays 159, such as liquid crystal displays (LCDs), gas plasma-based flat panel displays, organic light emitting diode (OLED) displays, electrophoretic ink (“E-ink”) displays, projectors, or other types of display devices. In some instances, the display 159 can be a component of the client device 106 or can be connected to the client device 106 through a wired or wireless connection.

The client device 106 can be configured to execute various applications such as a client application 163 or other applications. The client application 163 can be executed in a client device 106 to access network content served up by the computing environment 103 or other servers, thereby rendering a user interface 166 on the display 159. To this end, the client application 163 can include a browser, a dedicated application, or other executable, and the user interface 166 can include a network page, an application screen, or other user mechanism for obtaining user input. The client device 106 can be configured to execute applications beyond the client application 163 such as email applications, social networking applications, word processors, spreadsheets, or other applications.

The servers 107 are representative of a cluster of servers that can be coupled to the network 109. The servers 107 can be a group of servers 107 that work together as a single unit to provide services. To this end, the servers 107 can be interconnected and manage workloads and data collectively. In some examples, the servers 107 can be a part of the computing environment 103. In various examples, the servers 107 can have resources 169. Resources 169 can represent physical components (e.g., hard drive) or virtual components (e.g., files, network connections, memory space, etc.) that the servers 107 use to function. In various examples, resources 169 can be limited in availability or capacity.

Next, a general description of the operation of the various components of the network environment 100 is provided. Although the following description provides one illustrative example of the operations of and interactions between the various components of the network environment 100, other operations and interactions are also encompassed by the various embodiments of the present disclosure. More detailed discussion of the operations of individual components is provided in the discussion accompanying the subsequent drawings.

To begin, the optimization service 113 can receive a data pre-processing query 133 and a description of a task. Then, the code parameter extractor 116 of the optimization service 113 can extract the data components of the data pre-processing query 133, including tables 136, operations 139 and timeframes 143. In some examples, the code parameter extractor 116 can identify the tables 136 used in the data pre-processing query 133, search for operations 139 in the vicinity of the tables 136, or identify the timeframes 143 of the operations 139. Next, the code parameter extractor 116 can identify and convert non-database tables to platform tables for extraction. In some examples, the code parameter extractor 116 can determine the size of the custom tables and multiply the size of the custom tables by a compression factor to map the custom tables to platform tables. Then, the rank ordered resource recommender 119 of the optimization service 113 can sort the tables 136 based at least in part on a determined partition size category 146 or partition quantity category 149.

Further, the rank ordered resource recommender 119 can determine a rank ordered resource recommendation 156 based at least in part on the determined partition size category 146, the determined partition quantity category 149, the operations 139, or the timeframes 143. For example, the rank ordered resource recommender 119 can map the partition size category 146, the partition quantity category 149, the operations 139, or the timeframes 143 to a structured database (e.g. the optimization service database 153). In various example, the rank ordered resource recommender 119 can generate a combination of settings form individual sub queries and rank the combination of settings based at least in part on the time of initiation and execution. Therefore, in some examples, the rank ordered resource recommender 119 can output the highest ranked combination of settings as the rank ordered resource recommendation 156. In various examples, based at least in part on the rank ordered resource recommendation, the optimization service 113 can allocate resources 169 to execute the task using the data from the data preprocessing query 133.

Based at least in part on the success of the rank ordered resource recommender 119, the optimization service 113 can receive notice from a user requesting an addition recommendation of settings. Next, the cluster availability identifier 123 of the optimization service 113 can identify a cluster utilization percentage. In some examples, the cluster utilization percentage can be based at least in part on the executor memory, the executor core, the minimum executor, or the maximum executor. Then, the dynamic score adjuster 126 can adjust the maximum executor to modify the cluster utilization percentage. The dynamic score adjuster 126 can combine the rank ordered resource recommendation 156 with the cluster utilization percentage to determine a revised rank ordered resource recommendation.

Next, the optimization service 113 can adjust an allocation of resources 169 to execute the task based at least in part on the revised rank ordered resource recommendation 156. Finally, the optimization service 113 can execute the task using the adjusted allocation of resource 169 from the servers 107.

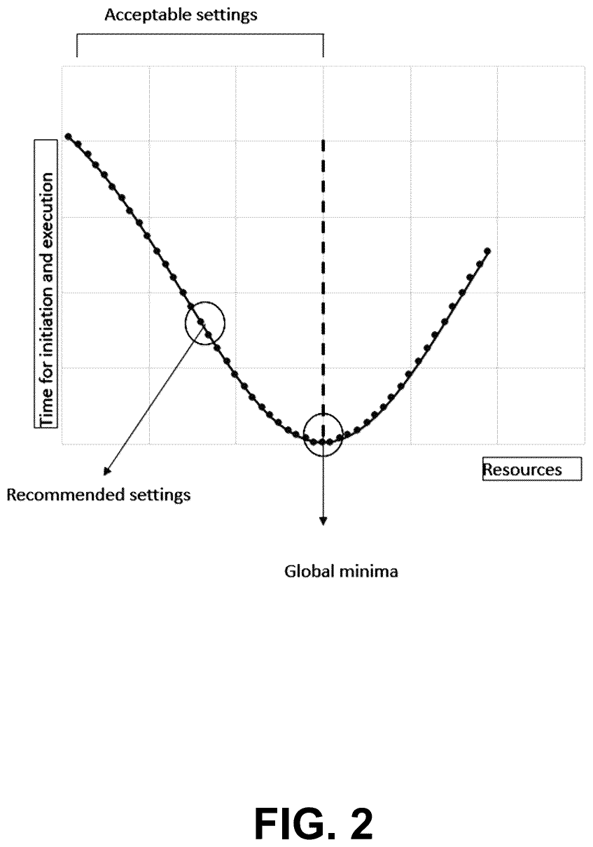

Referring next to FIG. 2, shown is a graphical representation of the time for initialization and execution as compared to the number of resources. The graph indicated the global minimum where the number of resources correspond the lowest feasible timeframe from initialization and execution. This analysis can be used for determining the rank ordered resource recommendations 156. In some examples, the recommended settings can be the point where the time of initiation and execution is approximately 10% more than the optimal time. Based at least in part on experimentation and analysis, the last 10% of time optimization has been observed to require the most resources. Therefore, the optimal settings can be determined where the timeframes of initiation and execution is a fraction of the global minima.

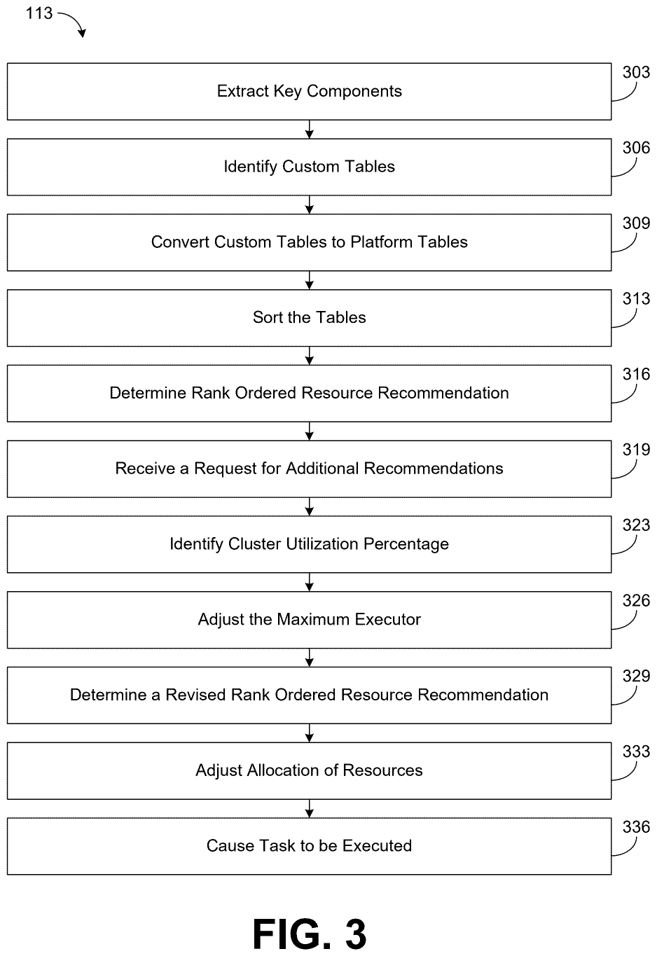

Referring next to FIG. 3, shown is a flowchart that provides one example of the operation of a portion of the optimization service 113. The flowchart of FIG. 3 provides merely an example of the many different types of functional arrangements that can be employed to implement the operation of the depicted portion of the optimization service 113. As an alternative, the flowchart of FIG. 3 can be viewed as depicting an example of elements of a method implemented within the network environment 100.

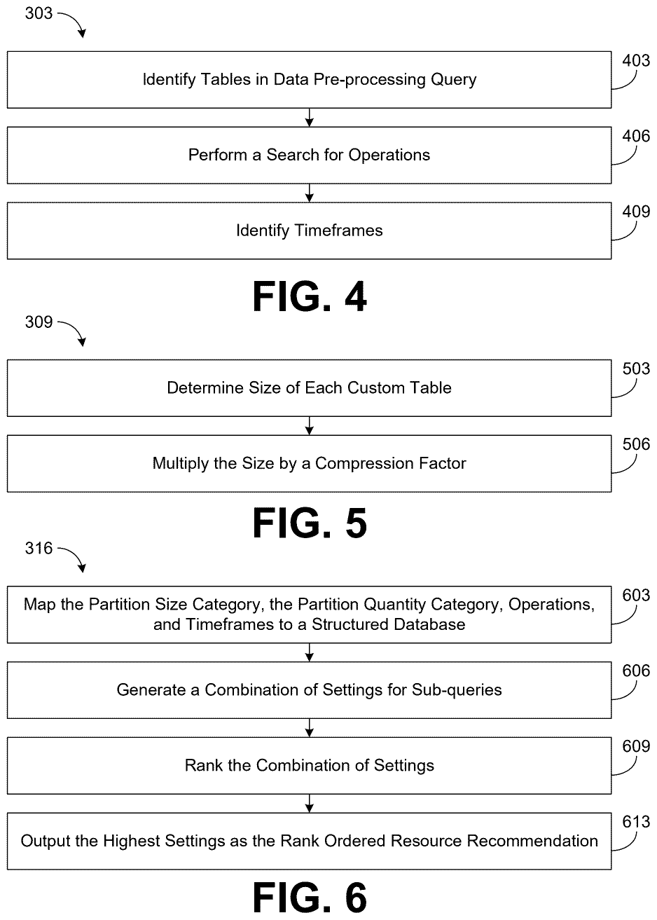

Beginning with block 303, the optimization service 113 can extract data components from a data pre-processing query 133. The optimization service 113 can employ a code parameter extractor 116 to extract data components. In some examples, the optimization service 113 can receive a data pre-processing query 133. For example, a data pre-processing query 133 can be a combination of tables 136, timeframes 143 on which those tables 136 are used, and operations 139 applied on those tables 136. The optimization service 113 can search the data pre-processing query 133 to identify the tables 136, operations 139, and timeframes 143. Details of this search are further described in reference to FIG. 4.

In some embodiments, the optimization service 113 can extract the data based at least in part on receiving a description of a task to be executed. In these embodiments, the optimization service 113 could receive a description of the task to be executed using the data to be preprocessed. The description of the task could include instructions for how to execute the task, what data to use to perform the task, etc. For example, the description of the task could indicate that the data is to be used to train a machine learning model and identify the data to be used for training purposes and the model to be used for training.

Next, at block 306, the optimization service 113 can identify custom tables. In some examples, the optimization service 113 can have the capability to identify and extract platform tables and custom tables. This step can be completed by the code parameter extractor 116 of the optimization service 113. For example, the optimization service 113 can search the data pre-processing query 133 and identify custom database tables where data is present in file format.

At block 309, the optimization service 113 can convert the custom tables to platform tables. To make use of the custom tables, the optimization service 113 can map all the identified custom tables from block 306 to similar standard platform database tables. For example, the optimization service 113 can convert the data size specification of each custom table into a standardized data size specification of a platform table. In various examples, the optimization service 113 can use the code parameter extractor 116 for this conversion. For example, the optimization service 113 can extract metadata from the custom database table and map the custom table to a platform table. Details of the conversion are further discussed in FIG. 5.

Then, at block 313, the optimization service 113 can sort the tables 136. To sort the tables 136, the optimization service 113 can use a rank ordered resource recommender 119. The optimization service 113 can determine the partition size information get the size of the tables 136 and determine a partition size category for the table 136. For example, a table 136 with seventy-five (75) gigabytes of data per partition can be categorized as a medium sized table 136. The optimization service 113 can also calculate the number of partitions of a table 136 using the refresh frequency information. For example, tables 136 with eight (8) partitions can be categorized as a model with small data. Using these determinations, the tables 136 can be categorized based at least in part on a partition size category 146 or a partition quantity category 149.

Moving to block 316, the optimization service 113 can determine the rank ordered resource recommendations 156. Based at least in part on the categorization determined in block 313, the optimization service 113 can rank settings to determine the rank ordered resource recommendations 156. The optimization service 113 can use the rank ordered resource recommender 119 to rank the settings. For example, the optimization service 113 can run experiments on multiple tables 136 with different configuration settings to determine an optimized setting recommendation. For example, the optimization service 113 can follow a bottom-up approach for optimizing different operations. The optimization service 113 can store the experimentation and successful executions in the optimization service database 153 for future reference. In various examples, the resources 169 of the rank ordered resource recommendations can correspond to a plurality of resources 169 from a cluster of servers 107. Based at least in part on the rank ordered resource recommendation 156, the optimization service 113 can cause resources 169 to be allocated for a particular task. In various examples, the resources 169 can be allocated to execute the task using data from the data preprocessing query 133. Determination of the rank ordered resource recommendations 156 is further discussed in reference to FIG. 6.

Next, at block 319, the optimization service 113 can receive a request for additional recommendations. For example, a user could request additional setting from the optimization service 113. In various examples, the optimization service database 153 can be updated based at least in part on disapproval of the original rank ordered resource recommendation 156.

At block 323, the optimization service 113 can identify cluster utilization percentage. For example, the cluster utilization percentage can be based at least in part on an executer memory, an executor core, a minimum executor, and a maximum executor. In various examples, the cluster availability at a particular moment can play a significant role in deciding additional resources that can be allocated to each of the queued jobs. The cluster availability identifier 123 of the optimization service 113 can be used to determine the cluster availability. The factors including executer memory, executor core, minimum executor, and maximum executor can denote the resources allocated to a data preprocessing workload.

Then, at block 326, the optimization service 113 can adjust the maximum executor based at least in part on the cluster utilization percentage. The cluster availability identifier 123 can manipulate the maximum executor while keeping the other three factors (executor memory, executor core, and minimum executor) constant to optimize utilization. In various examples, as the settings are updated based at least in part on these calculations, the new settings can be stored in the optimization service database 153.

Moving on, at block 329, the optimization service 113 can determine revised rank ordered resource recommendations 156. For example, the dynamic score adjuster 126 of the optimization service 113 can be used to combine the original rank ordered resource recommendations 156 with the dynamic score as calculated using the utilization identified in block 326. The combination of the original rank ordered resource recommendations 156 with the dynamic score can be used to generate revised rank ordered resource recommendations 156. The revised rank ordered resource recommendation can be outputted to the user. If the user finds the settings acceptable, the process can proceed. If the user wishes for more settings to be generated, the process can proceed to block 319, reiteratively proceeding through the process.

Then, at block 333, the optimization service 113 can adjust an allocation of the resources 169. For example, the optimization service 113 could send a message, instruction, request, etc. to cluster management software, hypervisor software, etc. to adjust an allocation of resources 169 of the servers 107. This could cause the cluster management software or hypervisor to adjust the resources available for execution of the task. For example, the cluster management software, hypervisor software, etc., could adjust an amount of memory, bandwidth, or CPUs assigned to one or more virtual machines allocated for performing the task. As another example, the cluster management software, hypervisor software, etc. could adjust a number of virtual machines, containers, etc. assigned to or allocated for performing the task. In various examples, the adjustment of the allocation of the resources 169 can be based at least in part on the rank ordered resource recommendations 156 or the revised rank ordered resource recommendations 156. For example, the allocation of resource 169 can be the process of distributing resources 169 among different tasks to optimize utilization and avoid running out of resources 169. The allocation of the resources 169 can be adjusted in order to execute the task using data from the data preprocessing query 133.

Lastly, at block 336, the optimization service 113 can cause the task to be executed or performed by the servers 107. For example, the cluster management software, hypervisor software, etc. could send an acknowledgement or confirmation in response to the message, request, or instruction to reallocate resources sent at block 333. Once the response or acknowledgement is received, the optimization service 113 could send a message to a task manager to instruct the task manager to begin execution of the task, thereby causing the task to be executed by the servers 107 using the resources allocated at block 333.

Referring next to FIG. 4, shown is a flowchart that provides one example of the operation of a portion of the optimization service 113. The flowchart shown in FIG. 4 is one example of the operation of the code parameter extractor 116 of the optimization service 113 according to various embodiments of the present disclosure. The flowchart of FIG. 4 provides merely an example of how block 303 is achieved. As an alternative, the flowchart of FIG. 4 can be viewed as depicting an example of elements of a portion of a method implemented within the network environment 100.

Beginning with block 403, the code parameter extractor 116 can identify tables 136 in a data pre-processing query 133. For example, the code parameter extractor 116 can employ a SQL metadata package to identify the tables 136 in the data pre-processing query 133.

Next at block 406, the code parameter extractor 116 can perform a search for operations 139. The operations 139 can represent the operations 139 bring applied on the tables 136 identified and extracted in block 403. For example, the code parameter extractor 116 can perform a regex search for operations 139 in the vicinity of the tables 136 while maintaining an ideal query structure.

Then at block 409, the code parameter extractor 116 can identify timeframes 143. The timeframes 143 can represent the timeframe 143 on which the tables 136 from block 403 are used from the data pre-processing query 133. For example, the code parameter extractor 116 can identify hive configuration variables that define the timeframes 143 of the data.

Referring next to FIG. 5, shown is a flowchart that provides one example of the operation of a portion of the optimization service 113. The flowchart shown in FIG. 5 is one example of the operation of the code parameter extractor 116 of the optimization service 113 according to various embodiments of the present disclosure. The flowchart of FIG. 5 provides merely an example of how block 309 is achieved. As an alternative, the flowchart of FIG. 3 can be viewed as depicting an example of elements of a portion of a method implemented within the network environment 100.

Beginning with block 503, the code parameter extractor 116 can determine the size of each custom table. For example, the size of the custom table can be calculated using the path provided by the user. In some examples, since the whole table is read by the user, the number of partitions can be set to 1.

Then at block 506, the code parameter extractor 116 can multiply the size by a compression factor. For example, based at least in part on the format the table is stored in, the size of the custom table identified in block 503, can be multiplied by a compression factor of a specific file type. In other words, for each format, there is a compression factor which is multiple to get the real size of the table. Based at least in part on this calculation, the custom table can be mapped to a platform table.

Referring next to FIG. 6, shown is a flowchart that provides one example of the operation of a portion of the optimization service 113. The flowchart shown in FIG. 6 is one example of the operation of the rank ordered resource recommender 119 of the optimization service 113 according to various embodiments of the present disclosure. The flowchart of FIG. 6 provides merely an example of how block 316 is achieved. As an alternative, the flowchart of FIG. 6 can be viewed as depicting an example of elements of a portion of a method implemented within the network environment 100.

Beginning with block 603, the rank ordered resource recommender 119 can map the partition size category 146, the partition quantity category 149, operations 139, and timeframes 143 to a structured database. In some examples, the structured database can be the optimization service database 153. For example, based at least in part on the categorization of the tables 136, the rank ordered resource recommender 119 can map each table 136 to a table 136 with similar settings in the optimization service database 153.

Next, at block 606, the rank ordered resource recommender 119 can generate a combination of settings for sub-queries. For example, the rank ordered resource recommender 119 can pull settings from the optimization service database 153 from previous experimentations and successful execution with the suggested settings. In various examples, by optimizing individual tables, the rank ordered resource recommender 119 can follow a bottom-up approach for optimizing the data pre-processing query.

At block 609, the rank ordered resource recommender 119 can rank the combination of settings. For example, the rank ordered resource recommender 119 can determine a ranked order of the setting to optimize performance of the table 136 based at least in part on the complexity of the data pre-processing query 133. For example, the rank ordered resource recommender 119 can recommend settings where the time of initiation and execution is 10 percent more than the optimal time of performance.

Then at block 613, the rank ordered resource recommender 119 can output the highest settings as the rank ordered resource recommendation 156. Based at least in part on the ranking completed in block 609, the rank ordered resource recommender 119 of the optimization service 113 can output the rank ordered resource recommendation 156 to the user. For example, the top three setting can be produced as the rank ordered resource recommendation 156.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or several interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a computing device comprising a processor and a memory;
machine-readable instructions stored in the memory that, when executed by the processor, cause the computing device to at least:
extract a plurality of data components from a data pre-processing query in response to receiving a description of a task, wherein the data components include at least one or more identified tables and at least one of one or more operations or one or more timeframes;
identify at least one or more custom tables in the one or more identified tables, the one or more custom tables having custom data size specifications;
convert respective data size specifications of the one or more custom tables into respective standardized data size specifications of one or more platform tables;
sort the one or more identified tables based at least in part on a partition size category or a partition quantity category;
determine a rank ordered resource recommendation based at least in part on the sorting of the one or more identified tables and at least one of the operations or the timeframes, the resources of the rank ordered resource recommendation corresponding to a plurality of resources from a cluster of servers; and
allocate the plurality of resources to execute the task using data from the data preprocessing query based at least in part on the rank ordered resource recommendation.

2. The system of claim 1, wherein the machine-readable instructions that cause the computing device to extract the plurality of data components from a data pre-processing query further cause the computing device to at least:
identify the one or more identified tables in the data pre-processing query;
perform a search for one or more operations associated with the one or more identified tables; and
identify one or more hive configuration variables defining the one or more timeframes.

3. The system of claim 1, wherein the machine-readable instructions that cause the computing device to convert respective data size specifications of the one or more custom tables into respective standardized data size specifications of one or more platform tables further cause the computing device to at least:
determine a size of individual ones of the one or more custom tables; and
multiply the size of individual ones of the one or more custom tables by a compression factor to map the one or more custom tables to one or more platform tables.

4. The system of claim 1, wherein the machine-readable instructions that cause the computing device to determine the rank ordered resource recommendation further cause the computing device to at least:
map the partition size category, the partition quantity category, the one or more operations or the one or more timeframes to a structured database;
generate a combination of settings for individual subqueries;
rank the combination of settings based at least in part on a timeframe of initiation and execution; and
output one or more of the highest ranked combination of settings as the rank ordered resource recommendation.

5. The system of claim 4, wherein the timeframe of initiation and execution of the highest ranked combination of settings is a fraction of a global minima of the timeframe of initiation and execution compared to a plurality of resources.

6. The system of claim 1, wherein the machine-readable instructions further cause the computing device to at least:
receive notice from a client device requesting an additional recommendation of settings;
identify a cluster utilization percentage, wherein the cluster utilization percentage is based at least in part on an executor memory, an executor core, a minimum executor, and a maximum executor;
adjust the maximum executor based at least in part on the cluster utilization percentage;
combine the rank ordered resource recommendation with cluster utilization percentage to determine a revised rank ordered resource recommendation; and
adjust the allocation of the plurality of resources to execute the task using data from the data preprocessing query based at least in part on the rank ordered resource recommendation.

7. The system of claim 1, wherein the machine-readable instructions further cause the computing device to at least cause the task to be executed using the allocation of resources from the cluster of servers, wherein the task is to train a machine learning model.

8. A method, comprising:
extracting, by a computing device, a plurality of data components from a data pre-processing query in response to receiving a definition of a task, wherein the data components include at least one or more identified tables and at least one of one or more operations or one or more timeframes;
sorting, by the computing device, the one or more identified tables based at least in part on a partition size category or a partition quantity category;
determining, by the computing device, a rank ordered resource recommendation based at least in part on the sorting of the one or more identified tables and at least one of the operations or the timeframes, the resources of the rank ordered resource recommendation corresponding to a plurality of resources from a cluster of servers; and
allocating, by the computing device, the plurality of resources to execute the task using data from the data preprocessing query based at least in part on the rank ordered resource recommendation.

9. The method of claim 8, wherein extracting the plurality of data components from a data pre-processing query further comprises at least:
identifying, by the computing device, the one or more identified tables in the data pre-processing query;
performing, by the computing device, a search for one or more operations associated with the one or more identified tables; and
identifying, by the computing device, one or more hive configuration variables defining the one or more timeframes.

10. The method of claim 8, wherein extracting the plurality of data components from a data pre-processing query further comprises at least:
identifying, by the computing device, at least one or more custom tables in the one or more identified tables, the one or more custom tables having custom data size specifications; and
converting, by the computing device, respective data size specifications of the one or more custom tables into respective standardized data size specifications of one or more platform tables.

11. The method of claim 10, wherein converting the respective data size specifications of the one or more custom tables into respective standardized data size specifications of one or more platform tables further comprises at least:
determining, by the computing device, the respective data size specifications of the one or more custom tables; and
multiplying, by the computing device, the respective data size specifications of the one or more custom tables by a compression factor to map the one or more custom tables to one or more platform tables.

12. The method of claim 8, wherein determining the rank ordered resource recommendation further comprises at least:
mapping, by the computing device, the partition size category, the partition quantity category, the one or more operations, or the one or more timeframes to a structured database;
generating, by the computing device, a combination of settings for individual subqueries;
ranking, by the computing device, the combination of settings based at least in part on a timeframe of initiation and execution; and
outputting, by the computing device, one or more of the highest ranked combination of settings as the rank ordered resource recommendation.

13. The method of claim 12, wherein the timeframe of initiation and execution of the highest ranked combination of settings is a fraction of a global minima of the timeframe of initiation and execution compared to a plurality of resources.

14. The method of claim 8, further comprising at least
receiving, by the computing device, notice from a client device requesting an additional recommendation of settings;
identifying, by the computing device, a cluster utilization percentage, wherein the cluster utilization percentage is based at least in part on an executor memory, an executor core, a minimum executor, and a maximum executor;
adjusting, by the computing device, the maximum executor based at least in part on the cluster utilization percentage;
combining, by the computing device, the rank ordered resource recommendation with cluster utilization percentage to determine a revised rank ordered resource recommendation; and
adjusting, by the computing device, an allocation of the plurality of resources to execute the task using data from the data preprocessing query based at least in part on the rank ordered resource recommendation.

15. The method of claim 8, further comprising at least causing the task to be executed using the allocation of resources from the cluster of servers, wherein the task is to train a machine learning model.

16. A non-transitory, computer-readable medium comprising machine-readable instructions that, when executed by a processor of a computing device, cause the computing device to at least:
extract a plurality of data components from a data pre-processing query in response to receiving a description of a task, wherein the data components include at least one or more identified tables and at least one of one or more operations or one or more timeframes;
identify at least one or more custom tables in the one or more identified tables, the one or more custom tables having custom data size specifications;
convert respective data size specifications of the one or more custom tables into respective standardized data size specifications of one or more platform tables;
sort the one or more identified tables based at least in part on a partition size category or a partition quantity category;
determine a rank ordered resource recommendation based at least in part on the sorting of the one or more identified tables and at least one of the operations or the timeframes, the resources of the rank ordered resource recommendation corresponding to a plurality of resources from a cluster of servers;
allocate the plurality of resources to execute the task using data from the data preprocessing query based at least in part on the rank ordered resource recommendation;
receive notice requesting an additional recommendation of settings;
identify a cluster utilization percentage, wherein the cluster utilization percentage is based at least in part on an executor memory, an executor core, a minimum executor, or a maximum executor;
adjust the maximum executor based at least in part on cluster utilization percentage;
combine the rank ordered resource recommendation with cluster utilization percentage to determine a revised rank ordered resource recommendation; and
adjust the allocation of the plurality of resources to execute the task using data from the data preprocessing query based at least in part on the rank ordered resource recommendation.

17. The non-transitory, computer-readable medium of claim 16, wherein the machine-readable instructions that cause the computing device to extract the plurality of data components from a data pre-processing query further cause the computing device to at least:
identify the one or more identified tables in the data pre-processing query;
perform a search for one or more operations associated with one or more identified tables; and
identify one or more hive configuration variables defining the one or more timeframes.

18. The non-transitory, computer-readable medium of claim 16, wherein the machine-readable instructions that cause the computing device to convert respective size specifications of the one or more custom tables into respective standardized data size specifications of one or more platform tables further cause the computing device to at least:
determine the respective data size specifications of the one or more custom tables; and
multiply the respective data size specifications of the one or more custom tables by a compression factor to map the one or more custom tables to a standardized data size specification of one or more platform tables.

19. The non-transitory, computer-readable medium of claim 16, wherein the machine-readable instructions that cause the computing device to determine the rank ordered resource recommendation further cause the computing device to at least:
map the partition size category, the partition quantity category, the one or more operations, or the one or more timeframes to a structured database;
generate a combination of settings for individual subqueries;
rank the combination of settings based at least in part on a timeframe of initiation and execution; and
output one or more of the highest ranked combination of settings as the rank ordered resource recommendation.

20. The non-transitory, computer-readable medium of claim 16, wherein the machine-readable instructions further cause the computing device to at least cause the task to be executed using the adjusted allocation of resources from the cluster of servers, wherein the task is to train a machine learning model.
